(19) United States
(12) Patent Application Publication
(10) Pub. No.: US 2010/0093403 A1
(43) Pub. Date: Apr. 15, 2010

(54) Touchscreen phone slider with dual pads

(76) Inventor: Ivan Miramontes, Fontana, CA (US)

Correspondence Address: Ivan Miramontes, 7637 Tamarind Ave., Fontana, CA, 92336, US

(21) Appl. No.: 12/572,874

(22) Filed: Oct. 2, 2009

Related U.S. Application Data
(60) Provisional application No. 61/195,039, filed on Oct. 3, 2008.

(51) Int. Cl. H04M 1/23

(52) U.S. Cl. 455/566; 345/173; 345/169; 455/575.4

(57) ABSTRACT

A portable device having a main unit and a keyboard unit. The main unit includes a touch screen display and the keyboard unit includes a full alphabet keyboard with QWERTY pad or the GAME pad which is accessed after sliding the back body down or up. Furthermore, Sliding the back body up exposes the other set of the dual keypads, then one rotates the device 180 degrees and the device is ready for use in conjunction with the touchscreen or rotate the device 180 degrees then slid the back body down.

### PREVIOUS APPLICATION

This application emanates from a previous provisional filing; Oct. 3, 2008 #61/195,039

### FIELD OF THE INVENTION

The present invention relates generally to portable electronic devices, and more specifically to a portable electronic device with in-play switchable full alphabet and game keypads.

### BACKGROUND OF THE INVENTION

As society becomes increasingly mobile, there is an ever-growing demand for electronic devices that are more powerful and more portable. In general, technology has answered this demand with lighter and stronger materials, and miniaturized electronics. For example, modern cellular telephones are small enough to be carried in a shirt pocket and powerful enough to send and receive electronic mail and perform electronic gaming functions.

One drawback, however, of creating smaller devices is the decreasing amount of surface area on which to locate a convenient user interface. From an ergonomic point of view, the smaller the human interface is on a portable device, the harder it is to operate. Moreover, as a portable device becomes more capable, a more complex interface for the device is typically needed. Thus, there is increasing difficulty in portable device design to achieve devices that are smaller and more powerful, yet convenient to use.

The current device brings together a Smart phone w/slider QWERTY and a portable game console. The Smart phone incorporates both QWERTY and game keys on a single “slider” keypad. Also, the device is able to seamlessly switch between keypads without losing connection to the game been played.

### SUMMARY OF THE INVENTION

Accordingly, the present invention provides a highly portable device having a full alphabet keyboard and display. The full alphabet keyboard can be operated when the device is in a compact “closed” configuration and in an ergonomic opens configuration. By providing a full alphabet keyboard usable in both the open and closed positions, data entry is easier and faster.

Thus, one aspect of the invention is a portable device having a main unit and a switchable keyboard unit. The main unit includes a display and the keyboard unit includes a full alphabet keyboard. Furthermore, the keyboard unit has a closed position and an open position. In the closed position, a portion of the display is obstructed by the keyboard unit. In the open position, the display is unobstructed by the keyboard unit. The full alphabet keyboard is operable in both the closed position and the open position.

The device is a touchscreen smart phone with a single sliding keypad. The sliding back body has a dual keypads lay-out, a QWERTY pad and a GAME pad. Both keypads are horizontally lay-out with one keypad covering the top half of the body and the other keypad covering the bottom half of the body.

The device is disclosed for use in two different orientations. In the first orientation, it's in the portrait (vertical) touchscreen mode. In the second orientation, its in the landscape (horizontal) touchscreen mode with either the QWERTY pad or the GAME pad exposed to the user after sliding the back body down or up.

Sliding the back body down exposes one set of the dual keypads and the device is ready for use in conjunction with the touchscreen. Sliding the back body up exposes the other set of the dual keypads, then one rotates the device 180 degrees and the device is ready for use in conjunction with the touchscreen (or rotate the device 180 degrees first, then slid the back body down). Note that when one keypad is exposed the other keypad is hidden and vice versa. When both sets of keypads (back body) are hidden away the device converts to the landscape (horizontal) touchscreen mode.

The device user is able to seamlessly switch between keypads without losing to connection to the multi player game. This feature is targeted for all gamers who are avid texters and chatters. For example, when a two player concludes a round-of-many rounds of a game, both are able to easily text and instant message (IM) each other in between rounds.

### BRIEF DESCRIPTION OF THE EMBODIMENT

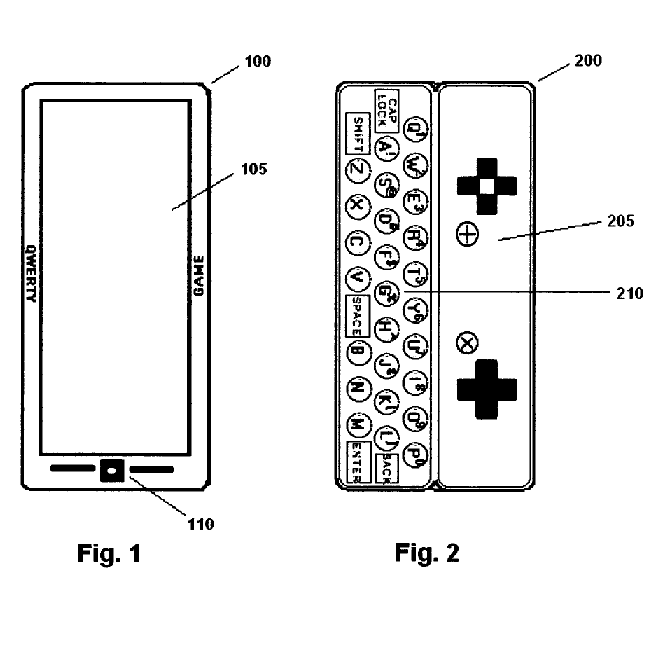

FIG. 1 is the view of the front of the device

FIG. 2 is the view of the back of the device

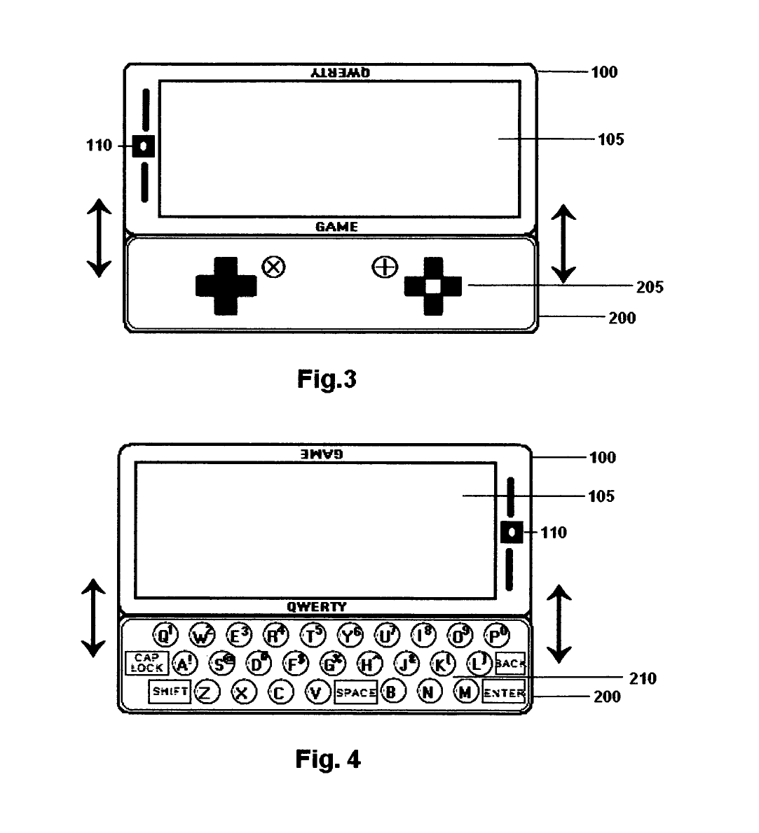

FIG. 3 is the view of the front of the device with game pad exposed

FIG. 4 is the view of the front of the device with QWERTY pad exposed

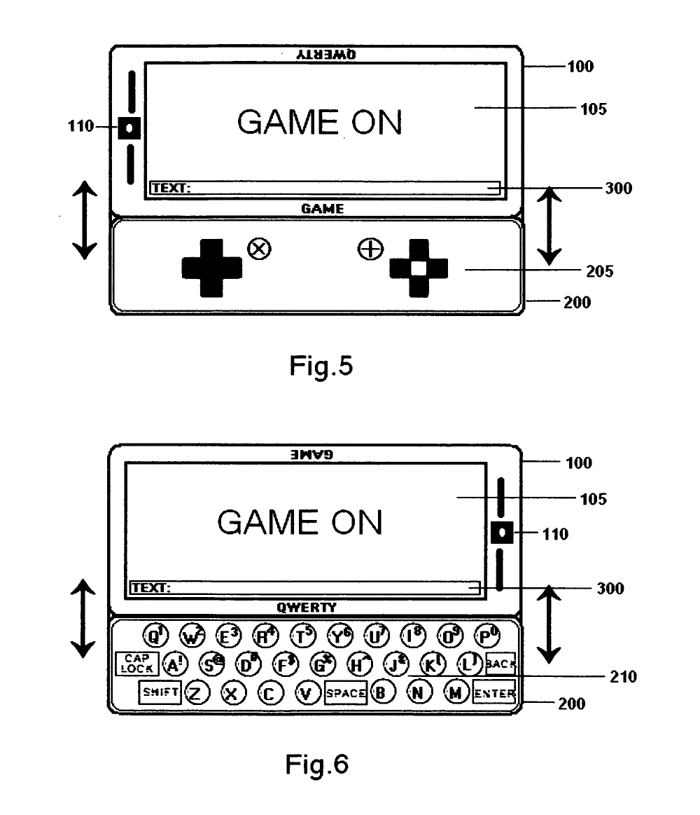

FIG. 5 is the front of the device in landscape mode.

FIG. 6 is the front view of the device in landscape mode with the QWERTY pad exposed.

### DESCRIPTION OF THE PREFERRED EMBODIMENT

FIG. 1 the front of the device in the vertical position. The front phone's body 100, the touchscreen 105, and the navigation keys 110.

FIG. 2 the slider back body 200 in the vertical position with both the QWERTY pad 210 and the game keys pad 205 laid out horizontal.

FIG. 3 the device in the landscape mode with the slider back body 200 slid down and the game keys pad 205 exposed. The QWERTY pad 210 (FIG. 4) is hidden underneath the lower sections of the front phone's body 100, the touchscreen 105, and the navigation keys 110.

FIG. 4 the device in the landscape mode with the slider back body 200 slid down and the QWERTY pad 210 exposed. The game pad 205 (FIG. 3) is hidden underneath the lower sections of the front phone's body 100, the touchscreen 105, and the navigation keys 110.

FIG. 5 the device in the landscape mode with the slider back body 200 slid down and the game keys pad 205 exposed and the texting mode feature 300 on. The QWERTY pad 210 (FIG. 6) is hidden underneath the lower sections of the front phone's body 100, the touchscreen 105, and the navigation keys 110. The device is able to seamlessly switch between keypads (205 and 210) without losing connection to the game being played (FIG. 5 and FIG. 6).

FIG. 6 the device is the landscape mode with the slider back body 200 slid down and the QWERTY keypad 210 exposed and the texting mode feature 300 on. The game pad 205 (FIG. 5) is hidden underneath the lower sections of the front phone's body 100, the touchscreen, and the navigation keys 110. The device is able to seamlessly switch between keypads (205 and 210) without losing connection to the game being played (FIG. 5 and FIG. 6). feature on.

I claim;

1. A touchscreen phone slider with dual pads comprising;
a. A wireless smart phone which embodies a sliding, two sided controlling keyboard wherein one side embodies a QWERTY keyboard layout while the opposing side embodies an electronic gaming console layout.
b. An operating system wherein electronic communication connections are continual regardless of the keyboard choosen.

2. A touchscreen phone slider with dual pads of claim 1 wherein only one controlling keypad can be visible at a time.

3. A touchscreen phone slider with dual pads of claim 1 wherein the screen imagery of the device is automatically oriented with the device orientation.

4. A touchscreen phone slider with dual pads of claim 1 wherein the keypad can be rotated 180 degrees to alter from QWERTY layout to gaming layout or the reverse.

5. A touchscreen phone slider with dual pads of claim 1 wherein texting mode and gaming mode can operate simultaneously.

6. A touchscreen phone slider with dual pads of claim 1 wherein either keypad can be operated without gaming disruption.
